(19) United States
(12) Patent Application Publication
(10) Pub. No.: US 2021/0191474 A1
(43) Pub. Date: Jun. 24, 2021

(54) KEYBOARD STRUCTURE AND ELECTRONIC DEVICE USING THE SAME

(71) Applicant: PEGATRON CORPORATION, Taipei (TW)

(72) Inventor: Chih-Hao Lu, Taipei (TW)

(21) Appl. No.: 17/072,209

(22) Filed: Oct. 16, 2020

(30) Foreign Application Priority Data
Dec. 20, 2019 (TW) 108217055

(51) Int. Cl. G06F 1/16

(52) U.S. Cl. CPC G06F 1/1669

(57) ABSTRACT

Disclosed are a keyboard structure and an electronic device using the keyboard structure. The electronic device includes a first display screen, a second display screen, and a keyboard structure. The keyboard structure is slidably disposed on the first display screen in a direction. The keyboard structure includes a keyboard module, a wiping cloth, and a scraper. The keyboard module includes a long side edge perpendicular to the direction. The wiping cloth is disposed on a lower surface of the keyboard module and is in contact with the display screen. The scraper is disposed at the long side edge of the keyboard module and is in contact with the display screen.

### CROSS-REFERENCE TO RELATED APPLICATION

This application claims the priority benefit of Taiwan application serial no. 108217055, filed on Dec. 20, 2019. The entirety of the above-mentioned patent application is hereby incorporated by reference herein and made a part of this specification.

### BACKGROUND

### Technical Field

The present disclosure relates to a keyboard structure, and in particular, to a movable keyboard structure applied to an electronic device.

### Related Art

Conventional folding notebook computers are mostly equipped with a display screen on one side, and are equipped with operating devices such as a keyboard and a touch pad on the other side. Due to prevalence and convenience of touchscreens, notebook computers with two touchscreens gradually appear. A virtual keyboard is displayed on a touchscreen to replace an ordinary conventional keyboard.

However, some users are still more accustomed to using a physical keyboard for typing. Therefore, an existing solution is to additionally dispose a removable or slidable physical keyboard on the display screen to resolve problems such as a poor operation feeling about the virtual keyboard or usage habits.

However, when the slidable keyboard is disposed on the display screen to slide, external dust or foreign matter falls onto a place between the physical keyboard and the display screen. In this case, if the physical keyboard slides on the display screen for multiple times, surface glass of the display screen will be scratched. Even if a buffer material is added between the physical keyboard and the display screen to reduce wear, a surface of the display screen will still be scratched due to the dust or foreign matter.

### SUMMARY

In view of this, the present disclosure provides a keyboard structure applied to an electronic device in an embodiment. The keyboard structure is slidably disposed on a display screen in a direction, and includes a keyboard module, a wiping cloth, and a scraper. The keyboard module includes a long side edge perpendicular to the direction. The wiping cloth is disposed on a lower surface of the keyboard module and is in contact with the display screen. The scraper is disposed at the long side edge of the keyboard module and is in contact with the display screen.

With the above structure, the keyboard structure of the present disclosure can be directly disposed above the display screen of the electronic device for use. By the disposition of the scraper, when the keyboard structure moves in a direction above the display screen, the scraper can block or scrape foreign matter, to prevent the foreign matter from entering a place between the keyboard module and the display screen to scratch a surface of the display screen during the moving. The wiping cloth disposed between the keyboard module and the display screen is directly attached to or in contact with the display screen. The contact with a relatively soft surface of the wiping cloth can not only reduce friction, but also provide a certain cleaning effect.

The present disclosure provides an electronic device in another embodiment, including a first display screen, a second display screen, and a keyboard structure. The second display screen is pivotally connected to the first display screen. The keyboard structure is slidably disposed on the first display screen in a direction. The keyboard structure includes a keyboard module, a wiping cloth, and a scraper. The keyboard module includes a long side edge perpendicular to the direction. The wiping cloth is disposed on a lower surface of the keyboard module and is in contact with the first display screen. The scraper is disposed at the long side edge of the keyboard module and is in contact with the first display screen.

As described above, the problem that the display screen is scratched by dust or foreign matter when the keyboard structure moves on the display screen can be avoided by using the scraper and the wiping cloth. In addition, dirt on the display screen can also be removed by the way. Moreover, for an electronic device with two display screens, the keyboard structure may alternatively be disposed on any display screen according to needs, to facilitate flexible application of a user.

To sum up, according to the keyboard structure and the electronic device using the same provided in the present disclosure, by disposition of the scraper, when the keyboard structure reciprocates on the display screen in a direction, the scraper on any side on the keyboard structure can block or scrape foreign matter on the surface of the display screen, to prevent the foreign matter from entering a place between the keyboard module and the display screen to scratch a surface of the display screen during the moving. The wiping cloth disposed between the keyboard module and the display screen is directly attached to or in contact with the display screen. The contact with the relatively soft surface of the wiping cloth can not only reduce friction, but also provide a certain cleaning effect.

The following elaborates detailed features and advantages of the present disclosure in implementations. The content is sufficient for any person familiar with related arts to understand and implement the technical content of the present disclosure. According to the content disclosed in this specification, the scope of patent application and the drawings, any person familiar with related arts can easily understand purposes and advantages of the present disclosure.

### BRIEF DESCRIPTION OF THE DRAWINGS

FIG. 1 is a schematic outside view of a keyboard structure of an electronic device according to a first embodiment of the present disclosure.

FIG. 2 is a schematic exploded view of a keyboard structure according to the first embodiment of the present disclosure.

FIG. 3 is a schematic cross-sectional view of a keyboard structure according to the first embodiment of the present disclosure.

FIG. 4 is a schematic exploded view of a keyboard structure according to a second embodiment of the present disclosure.

FIG. 5 is a schematic cross-sectional view of a keyboard structure according to the second embodiment of the present disclosure.

### DETAILED DESCRIPTION

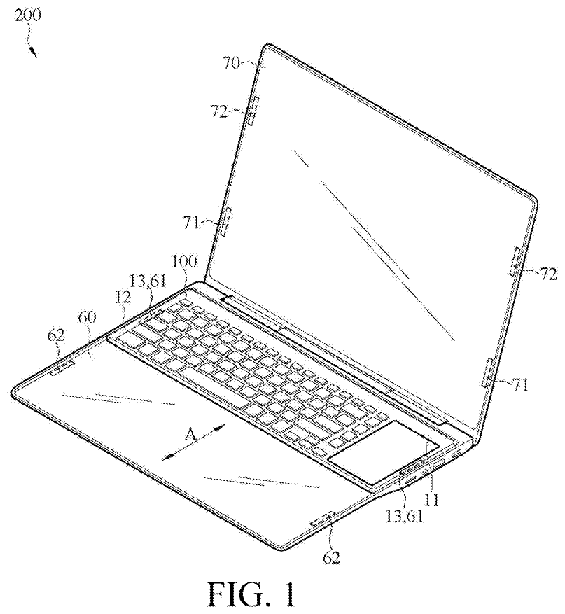

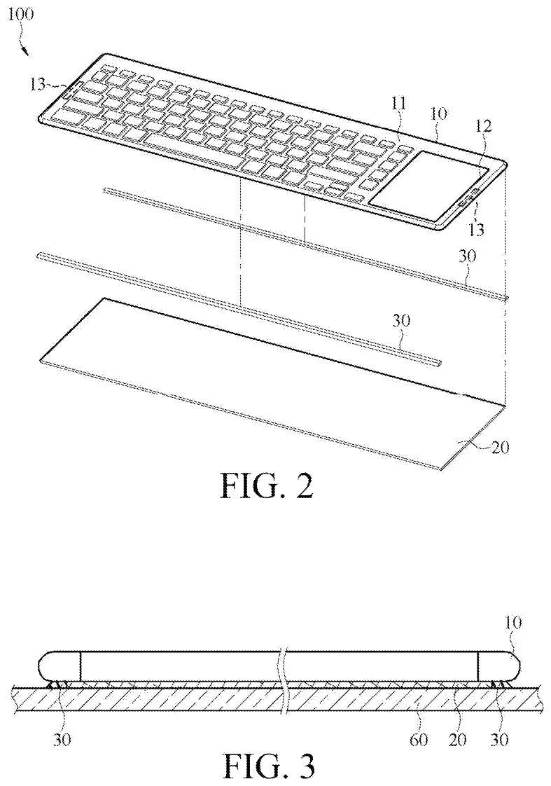

Referring to FIG. 1 and FIG. 2, FIG. 1 is a schematic outside view of a keyboard structure of an electronic device according to a first embodiment of the present disclosure. FIG. 2 is a schematic exploded view of a keyboard structure according to the first embodiment of the present disclosure. As shown in FIG. 1, an electronic device 200 of this embodiment includes a first display screen 60, a second display screen 70, and a keyboard structure 100. As shown in FIG. 2, the keyboard structure 100 of this embodiment includes a keyboard module 10, a wiping cloth 20, and at least one scraper 30. In some other embodiments, the electronic device 200 may only include the first display screen 60 and the keyboard structure 100, and the keyboard structure 100 is slidably disposed on the first display screen 60.

As shown in FIG. 1, in this embodiment, the second display screen 70 is pivotally connected to the first display screen 60. The keyboard structure 100 is slidably disposed above the first display screen 60 in a direction A. The keyboard module 10 includes a long side edge 11 perpendicular to the direction A and a short side edge 12 parallel to the direction A. In this embodiment, the first display screen 60 and the second display screen 70 are rectangles. The keyboard structure 100 is also a rectangle, and is disposed across a direction of a long side of the first display screen 60. A sliding direction of the keyboard structure 100 is a direction parallel to a short edge of the first display screen 60 or the second display screen 70. For example, as shown in FIG. 1, the direction A is a direction parallel to the short edge of the first display screen 60. When disposed on the first display screen 60, the keyboard structure 100 can slide back and forth along the direction shown by the direction A.

In some embodiments, two short side edges 12 of the first display screen 60 of the electronic device 200 each include a groove (not shown). A length of the groove approximates a length of the short side edge 12. The groove is configured to enable the keyboard structure 100 to slide along the direction A more smoothly without sliding out of the first display screen 60. Similarly, the second display screen 70 may also be provided with a same groove.

As shown in FIG. 1, in this embodiment, the keyboard module 10 of the electronic device 200 further includes first positioning pieces 13 that are respectively disposed on the two short side edges 12 of the keyboard module 10. The first display screen 60 includes two second positioning pieces 61 and two third positioning pieces 62. The second positioning pieces 61 and the third positioning pieces 62 are disposed corresponding to the short side edges 12. As can be seen in FIG. 1, in this embodiment, the second positioning pieces 61 and the third positioning pieces 62 are respectively disposed at different positions on the short side edges 12. In addition, the two second positioning pieces 61 and the two third positioning pieces 62 are respectively disposed on two opposite sides of the first display screen 60 perpendicular to the direction A to enhance a positioning effect. In some embodiments, one second positioning piece 61 and one third positioning piece 62 may be disposed on one short edge of the first display screen 60. There is no need to dispose one second positioning piece 61 and one third positioning piece 62 on each short edge on two sides. In this way, the keyboard module 10 can be controlled to be in different positions on the first display screen 60 through mutual attraction between the first positioning pieces 13 and the second positioning pieces 61, or between the first positioning pieces 13 and the third positioning pieces 62.

In this embodiment, the second display screen 70 may alternatively include two fourth positioning pieces 71 and two fifth positioning pieces 72. The fourth positioning pieces 71 and the fifth positioning pieces 72 are disposed corresponding to short side edges of the second display screen 70. As can be seen in FIG. 1, in this embodiment, the fourth positioning pieces 71 and the fifth positioning pieces 72 are respectively disposed at different positions on the short side edges of the second display screen 70. In addition, the two fourth positioning pieces 71 and the two fifth positioning pieces 72 are respectively disposed on two opposite sides of the second display screen 70 perpendicular to the direction A to enhance a positioning effect. In some embodiments, one fourth positioning piece 71 and one fifth positioning piece 72 may be disposed on one short edge of the second display screen 70. There is no need to dispose one fourth positioning piece 71 and one fifth positioning piece 72 on each short edge on two sides. In this way, the keyboard module 10 can be controlled to be in different positions on the second display screen 70 through mutual attraction between the first positioning pieces 13 and the fourth positioning pieces 71 or the fifth positioning pieces 72.

In this way, by disposition of the positioning pieces, the keyboard structure 100 can be disposed on the first display screen 60 or the second display screen 70 according to needs. In addition, the keyboard module 10 can slide on either side of the first display screen 60 or the second display screen 70, to facilitate flexible application of a user.

As shown in FIG. 1, in this embodiment, the two first positioning pieces 13, the two second positioning pieces 61, the two third positioning pieces 62, the two fourth positioning pieces 71, and the two fifth positioning pieces 72 may all be magnet pieces. When the two first positioning pieces 13 of the keyboard module 10 are correctly aligned with the two second positioning pieces 61 and the two third positioning pieces 62 that are disposed on the first display screen 60 together, or with the two fourth positioning pieces 71 and the two fifth positioning pieces 72 that are disposed on the second display screen 70 together, the keyboard module 10 can be fixed in a specific position through attraction between the magnet pieces. The following embodiment takes an example in which the keyboard module 10 is disposed on the first display screen 60, but the present disclosure is not limited thereto.

Referring to FIG. 2 and FIG. 3, FIG. 3 is a schematic cross-sectional view of a keyboard structure according to the first embodiment. As shown in FIG. 2 and FIG. 3, in this embodiment, the wiping cloth 20 is disposed on a lower surface of the keyboard module 10 and is in contact with the first display screen 60. The at least one scraper 30 is disposed at the long side edge 11 of the keyboard module 10 and is in contact with the first display screen 60. This embodiment takes an example in which two scrapers 30 are respectively disposed at the two long side edges 11 of the keyboard module 10. By a configuration in which one scraper 30 is disposed at each of two sides, when the keyboard structure 100 reciprocates above the first display screen 60 in the direction A, the scrapers 30 on the two sides can block or scrape dust or foreign matter, to prevent the dust or foreign matter from entering a place between the keyboard module 10 and the first display screen 60 to scratch a surface of the first display screen 60 during the moving. The wiping cloth 20 disposed between the keyboard module 10 and the first display screen 60 is directly attached to or in contact with the first display screen 60. The contact with a relatively soft surface of the wiping cloth 20 can not only reduce friction, but also provide a certain cleaning effect. In this embodiment, even if the dust or foreign matter enters a place between the keyboard module 10 and the first display screen 60, the wiping cloth 20 can attract or grab the dust or foreign matter by static electricity, to prevent the surface of the first display screen 60 from being scratched during the moving.

In this embodiment, the scraper 30 is a soft scraper, but is not limited thereto. In other embodiments, a material of the scraper 30 can be silica gel or rubber.

In this embodiment, the wiping cloth 20 is flannel, but is not limited thereto. In other embodiments, the wiping cloth 20 may be a cleaning sponge or a cotton wiper.

In this embodiment, the wiping cloth 20 is removably connected to the lower surface of the keyboard module 10. The electronic device 200 further includes first joint pieces that cooperate with each other, in which the first joint pieces the keyboard module 10 and the wiping cloth 20 respectively to be correspondingly attached or detached. In this embodiment, the description is made by using an example in which hook-and-loop fasteners that cooperate with each other are disposed at the keyboard module 10 and the wiping cloth 20 respectively as the first joint pieces, so that the keyboard module 10 and the wiping cloth 20 are correspondingly attached or detached, but the present disclosure is not limited thereto. In other embodiments, first joint pieces hat cooperate with each other are disposed at the keyboard module 10 and the wiping cloth 20 respectively, in which the first joint pieces may be mutually matched magnets for corresponding bonding or disassembly, or buckle components, lock components, etc. can be buckled or unbuckled correspondingly, so as to fix the wiping cloth 20 on the lower surface of the keyboard module 10. In this embodiment, the hook-and-loop fasteners are disposed on the two long side edges 11 of the keyboard module 10 and are correspondingly disposed on the wiping cloth 20, but the present disclosure is not limited thereto. In other embodiments, buckle components are disposed at four corners of the keyboard module 10 and are correspondingly disposed on the wiping cloth 20. The wiping cloth 20 is removably connected to the lower surface of the keyboard module 10. Therefore, a user may remove the wiping cloth 20 as required, to facilitate cleaning and replacement of the wiping cloth 20.

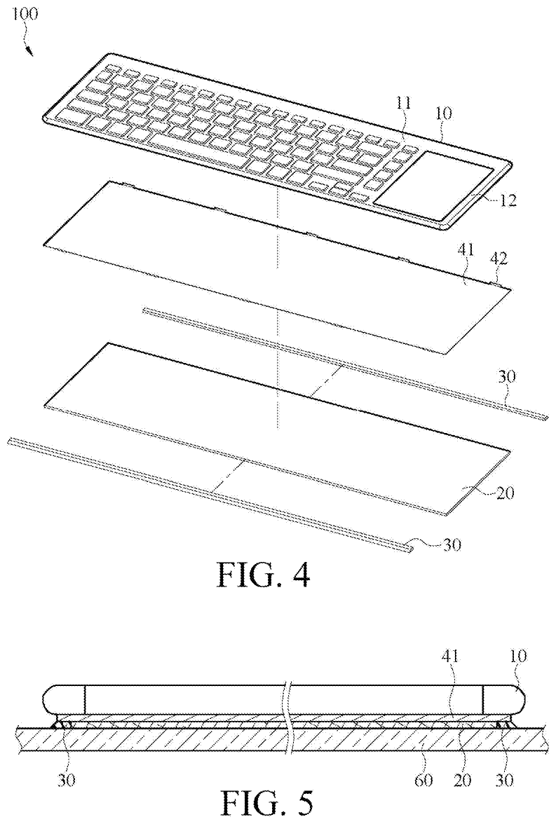

Referring to FIG. 4 and FIG. 5, FIG. 4 is a schematic exploded view of a keyboard structure according to a second embodiment. FIG. 5 is a schematic cross-sectional view of a keyboard structure according to the second embodiment. Components in this embodiment in common with those in the first embodiment will be marked with same component symbols, and are not repeated herein. As shown in FIG. 4, a difference from the first embodiment is that, in this embodiment, the keyboard structure 100 further includes a connecting piece 41, and a wiping cloth 20 and a scraper 30 are disposed on a lower surface of a keyboard module 10 through the connecting piece 41. The wiping cloth 20 and the scraper 30 can be fixed onto a lower surface of the connecting piece 41 through a method such as adhesion, and form an assembly removably assembled to the keyboard module 10 through the connecting piece 41. As shown in FIG. 4, in this embodiment, the connecting piece 41 is removably connected to the lower surface of the keyboard module 10. The electronic device 200 further includes second joint pieces that cooperate with each other, in which the second joint pieces are disposed at the keyboard module 10 and the connecting piece 41 respectively be correspondingly buckled or unbuckled. In this embodiment, buckles 42 that cooperate with each other are disposed at the keyboard module 10 and the connecting piece 41 respectively as the second joint pieces, so that the keyboard module 10 and the connecting piece 41 can be correspondingly buckled or unbuckled, but the present disclosure is not limited thereto. In other embodiments, the second joint pieces that cooperate with each other may be respective locking components that cooperate with each other or may be hook-and-loop fasteners, magnets, or the like, so that the keyboard module 10 and the connecting piece 41 are correspondingly attached or detached, to fix the connecting piece 41 onto the lower surface of the keyboard module 10. In this embodiment, the buckles 42 are disposed on the connecting piece 41, corresponding to two long side edges 11 of the keyboard module 10, but the present disclosure is not limited thereto. In other embodiments, the magnets are disposed on the two long side edges 11 of the keyboard module 10 and are correspondingly disposed on the connecting piece 41. The connecting piece 41 is removably connected to the lower surface of the keyboard module 10. Therefore, a user may remove the connecting piece 41 as required, to facilitate replacement of the wiping cloth 20 and cleaning of the scraper 30.

To sum up, the present disclosure provides the keyboard structure 100 and the electronic device 200 using the same. By disposition of the scraper 30, when the keyboard structure 100 reciprocates above the first display screen 60 in the direction A, the scraper 30 on any side on the keyboard structure 100 can block or scrape foreign matter on the surface of the first display screen 60, to prevent the foreign matter from entering a place between the keyboard module 10 and the first display screen 60 to scratch the surface of the first display screen 60 during the moving. The wiping cloth 20 disposed between the keyboard module 10 and the first display screen 60 is directly attached to or in contact with the first display screen 60. The contact with a relatively soft surface of the wiping cloth can not only reduce friction, but also provide a certain cleaning effect.

Although the present disclosure is disclosed above with the foregoing embodiments, the embodiments are not intended to limit the present disclosure. Anyone familiar with related arts may make some changes and improvements without departing from the spirit and scope of the present disclosure. Therefore, the patent protection scope of the present disclosure shall be subject to the claims attached to this specification.

What is claimed is:

1. A keyboard structure, slidably disposed on a display screen in a direction, the keyboard structure comprising:
a keyboard module, comprising a long side edge perpendicular to the direction;
a wiping cloth, disposed on a lower surface of the keyboard module and in contact with the display screen; and
a scraper, disposed at the long side edge of the keyboard module and in contact with the display screen.

2. The keyboard structure according to claim 1, wherein the keyboard module comprises another long side edge perpendicular to the direction, and the keyboard module further comprises another scraper disposed at the another long side edge of the keyboard module.

3. The keyboard structure according to claim 1, wherein the keyboard module further comprises a short side edge parallel to the direction and a first positioning piece, the first positioning piece is disposed at the short side edge, the display screen comprises a second positioning piece and a third positioning piece, and the second positioning piece and the third positioning piece are disposed corresponding to the short side edge, to enable the keyboard module to be in different positions on the display screen through mutual attraction between the first positioning piece and the second positioning piece or the third positioning piece.

4. The keyboard structure according to claim 1, wherein the wiping cloth is removably connected to the lower surface of the keyboard module.

5. The keyboard structure according to claim 3, further comprising first joint pieces disposed at the keyboard module and the wiping cloth respectively to be correspondingly attached or detached.

6. The keyboard structure according to claim 1, further comprising a connecting piece, wherein the connecting piece is disposed on the lower surface of the keyboard module, and the wiping cloth and the scraper are connected to the keyboard module through the connecting piece.

7. The keyboard structure according to claim 6, wherein the connecting piece is removably connected to the lower surface of the keyboard module.

8. The keyboard structure according to claim 7, further comprising second joint pieces disposed at the keyboard module and the connecting piece respectively to be correspondingly buckled or unbuckled.

9. An electronic device, comprising:
a first display screen;
a second display screen, pivotally connected to the first display screen; and
a keyboard structure, slidably disposed on the first display screen in a direction, the keyboard structure comprising:
a keyboard module, comprising a long side edge perpendicular to the direction;
a wiping cloth, disposed on a lower surface of the keyboard module and in contact with the first display screen; and
a scraper, disposed at the long side edge of the keyboard module and in contact with the first display screen.

10. The electronic device according to claim 9, wherein the keyboard module comprises another long side edge perpendicular to the direction, and the keyboard module further comprises another scraper disposed at the another long side edge of the keyboard module.
